(19) United States
(12) Patent Application Publication
(10) Pub. No.: US 2026/0122658 A1
(43) Pub. Date: Apr. 30, 2026

(54) COHERENT RESOURCES FOR ASSOCIATED SERVICES

(71) Applicant: InterDigital Patent Holdings, Inc., Wilmington, DE (US)

(72) Inventors: Kevin Di Lallo, Laval (CA); Michel Roy, Candiac (CA); Michael Starsinic, Newtown, PA (US); Magurawalage Chathura Madhusanka Sarathchandra, London (GB); Achref Methenni, Montreal (CA); Patrice Hirtzlin, Betton (FR)

(73) Assignee: InterDigital Patent Holdings, Inc., Wilmington, DE (US)

(21) Appl. No.: 18/925,157

(22) Filed: Oct. 24, 2024

(51) Int. Cl. H04W 72/50; H04W 12/062; H04W 72/04

(52) U.S. Cl. CPC H04W 72/535; H04W 12/062; H04W 72/04

(57) ABSTRACT

Systems, methods, and instrumentalities are disclosed herein for a wireless transmit/receive unit (WTRU) and/or a network. A WTRU may include a processor configured to detect a request to create a service association (SA). The request may indicate a coherent resource and/or indicate policy information associated with creating a coherent resource policy. The WTRU may generate the coherent resource policy based on the coherent resource and the policy information. The WTRU may generate an SA create message. The SA create message may include an indication of the coherent resource and the coherent resource policy. The WTRU may send the SA create message to a network node. The SA create message may indicate a request to create the SA based on the coherent resource and/or the coherent resource policy. The WTRU may receive an SA create response message from the network node.

### BACKGROUND

Mobile communications using wireless communication continue to evolve. A fifth generation may be referred to as 5G. A previous (legacy) generation of mobile communication for example, may be fourth generation (4G) long term evolution (LTE).

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Systems, methods, and apparatuses related to coherent resources for associated services may be described herein. A device (e.g., a wireless transmit/receive unit (WTRU)) may include a processor configured to perform one or more actions. The device may detect a request to create a service association (SA). The request may indicate a coherent resource and/or indicate policy information associated with creating a coherent resource policy. The device may generate the coherent resource policy based on the coherent resource and/or the policy information. The device may generate an SA create message. The SA create message may include an indication of the coherent resource and/or the coherent resource policy. The device may send the SA create message to a network node. The SA create message may indicate a request to create the SA based on the coherent resource and/or the coherent resource policy. The device may receive an SA create response message from the network node. The SA create response may indicate that the SA has been created and/or an SA identifier (SAID) based on the coherent resource policy.

The device may include features as described herein. For example, the device may detect a request to update the coherent resource. The request to update the coherent resource may indicate the coherent resource and/or the SAID. The device may send a coherent resource update request to the network node. The coherent resource update request may indicate a request to update the coherent resource, a coherent resource version identifier, and/or the SAID. The device may receive a coherent resource update response. The coherent resource update response may indicate that the coherent resource has been updated, a version identifier for the coherent resource, and/or the SAID. The SA create message may indicate at least one of requestor information, associated service information, or a version or a timestamp associated with the coherent resource. The coherent resource may be a spatial map. The SA create message may indicate at least one of a spatial mapping service, a spatial localization service, a spatial anchor service, or access information. The SA create response message may indicate at least one of an authorized associated services management function (ASMF) operation for the device or an SAID. The information associated with creating the coherent resource policy may include at least one of a resource type, a resource version, a resource information layer, a resource synchronization threshold, a resource consumer type, a resource consumer inter-dependency, a resource consumer state, an expected resource usage, a time, or a device location. The SA create message may indicate at least one of an associated services management function client component (ASMF-C) identifier, security credentials, a notification endpoint, or an external identifier to enable the network node to subscribe to event notifications. The SA create message may indicates coherent resource information, wherein the coherent resource information comprises at least one of a resource identifier, a resource type, a resource location, a resource size, a resource version, resource access credentials, or a resource filter.

A device (e.g., a WTRU) may include a processor configured to perform one or more actions. The device may detect a request to join a SA. The request to join the SA may indicate a SAID associated with the SA, a coherent resource, and/or a coherent resource policy. The device may generate an SA join request message. The SA join request message may include an indication of the SAID associated with the SA, the coherent resource, and/or the coherent resource policy. The device may send the SA join request message to a network node. The device may receive an SA join response message. The SA join response message may indicate that the device has joined the SA, an SA member identifier (SAMID), and/or information associated with the coherent resource.

The device may receive a coherent resource update message from the network node. The coherent resource update message may indicate that the coherent resource has been updated, a version identifier for the coherent resource, and/or the SAMID. The device may retrieve an updated coherent resource based on the version identifier for the coherent resource and/or the SAMID. The SA join request message may include an indication of at least one of security credentials, a notification endpoint, or a device identifier. The SA join response message may indicate a coherent resource update configuration for the device based on the coherent resource policy. The coherent resource update configuration may identify a synchronization threshold associated with updating the coherent resource. The coherent resource policy may include at least one of a resource type, a resource version, a resource information layer, a resource synchronization threshold, a resource consumer type, a resource consumer inter-dependency, a resource consumer state, an expected resource usage, a time, or a device location. The SA join request message may indicate coherent resource information. The coherent resource information may include at least one of a resource identifier, a resource type, a resource location, a resource size, a resource version, resource access credentials, or a resource filter.

A first network node may provide an associated service, the first network node may include a processor. The first network node may receive an SA create request message from a WTRU (e.g., a device). The SA create request message may indicate a coherent resource, a coherent resource policy, and/or a request to create an SA based on the coherent resource and/or the coherent resource policy. The first network node may create the SA, wherein the SA comprises a SAID based on the coherent resource and/or the coherent resource policy. The first network node may send an SA create response message to the device. The SA create response message may indicate that the first network node created the SA and/or the SAID. The first network node may receive an SA join request message from the device. The SA join request message may indicate a request to join the SA, the SAID, the coherent resource, and/or the coherent resource policy. The first network node may, based on the SA join request message, generate a SAMID. The SAMID may be generated based on a determination to add the device to the SA. The first network node may send an SA join response message to the device. The SA join response message may indicate that the device has joined the SA and/or the SAMID.

The first network node may include features as described herein. For example, the first network node may receive a coherent resource update request from the device. The coherent resource update request may indicate a request to update the coherent resource, a coherent resource version identifier, and/or the SAID. The first network node may send a coherent resource update response to the device. The coherent resource update response may indicate that the coherent resource has been updated and/or a version identifier for the coherent resource. The first network node may, based on the received coherent resource update request, determine an SA member associated with the coherent resource. The first network node may send the coherent resource update notification to the SA member. The coherent resource update response may indicate that the coherent resource has been updated, a version identifier for the coherent resource, and/or the SAMID. The SA create request message may indicate a resource filter that identifies the coherent resource. The first network node may create the SA based on the resource filter. The SA create request message may indicate at least one of an ASMF-C identifier, security credentials, a notification endpoint, or an external identifier to enable the network node to subscribe to event notifications.

Other examples of this aspect include corresponding computer systems, apparatus, and computer programs recorded on one or more computer storage devices, each configured to perform the actions of the methods.

Each feature disclosed anywhere herein is described, and may be implemented, separately/individually and in any combination with any other feature disclosed herein and/or with any feature(s) disclosed elsewhere that may be impliedly or expressly referenced herein or may otherwise fall within the scope of the subject matter disclosed herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of resource copies in a distributed system.

FIG. 3 is a diagram illustrating an example for creating a service association.

FIG. 4 is a diagram illustrating an example for joining a service association.

FIG. 5 is a diagram illustrating an example for updating a coherent resource for a service association.

### DETAILED DESCRIPTION

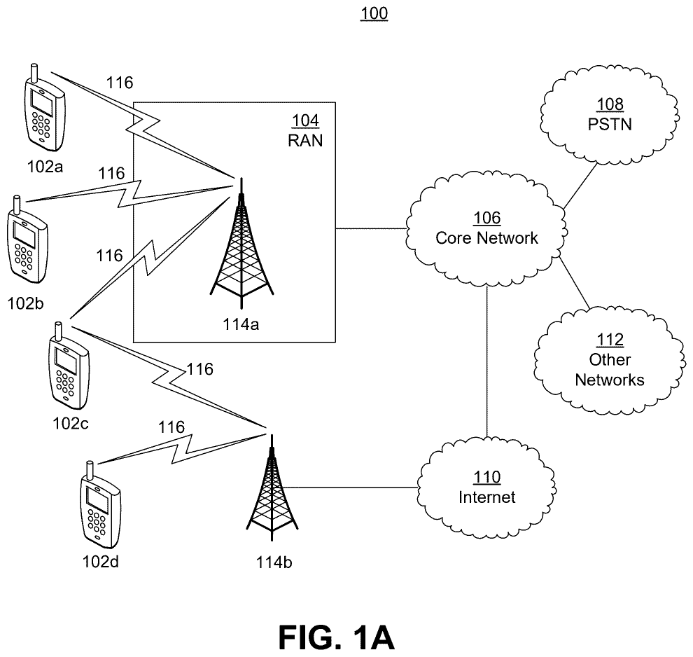

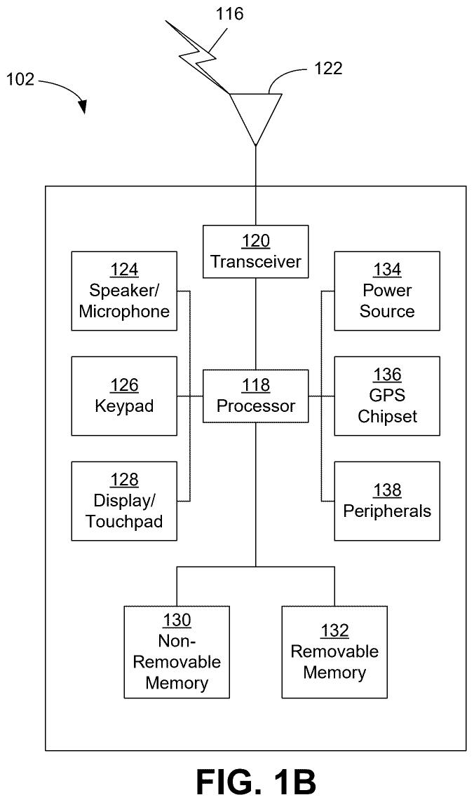

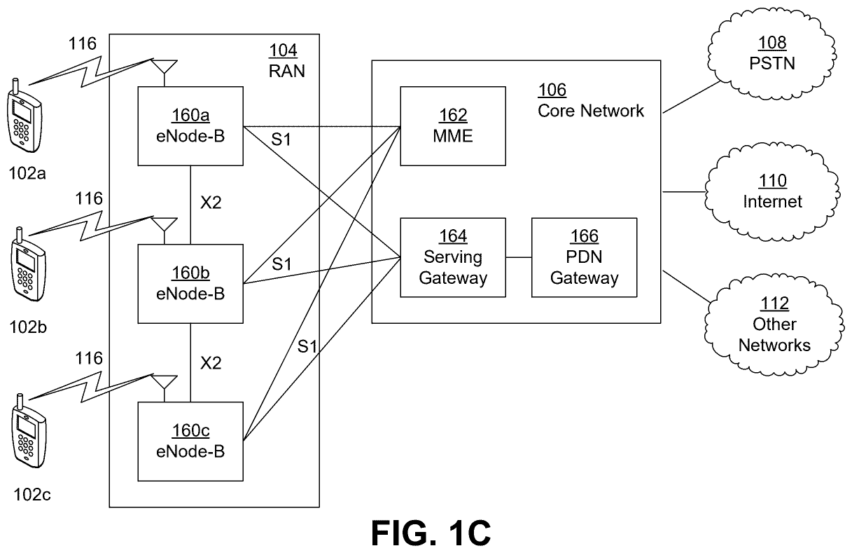

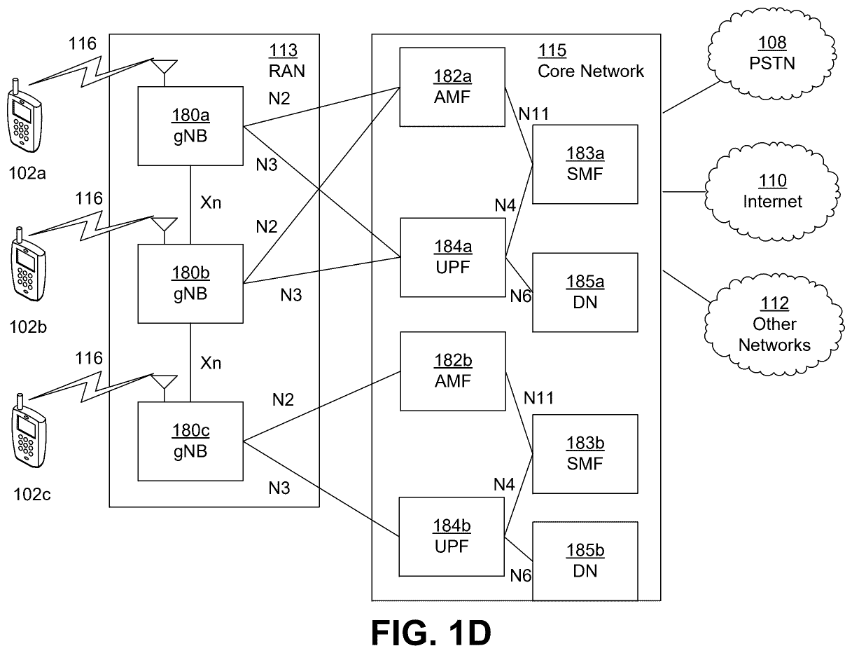

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Reference to a timer herein may refer to a time, a time period, a tracking of time, a tracking of a period of time, a combination thereof, and/or the like. Reference to a timer expiration herein may refer to determining that the time has occurred or that the period of time has expired.

Enhancements to enable a consumer application (e.g., an application client (AC) on a WTRU or an application server (AS) in a DN) to manage and maintain coherent resources for a set of associated applications and/or services may be described herein. The proposed enhancements may allow the consumer application to indicate (e.g., via a policy), the conditions under which the associated applications and/or services are notified about available resource updates.

Features described herein may enable metaverse deployments, with multiple application and/or service providers, to efficiently coordinate and manage real-time access to resources for sets of related services. An associated services management function (ASMF) may be proposed (e.g., as an enhancement to the 3GPP core network or service enablement layer), to manage sets of associated services requiring access to coherent copies of a resource.

In examples described herein, the terms AS and application function (AF) may be used interchangeably.

The term coherent may refer to a situation where two or more consumers read a resource (e.g., the same resource), and the two or more consumers (e.g., all of the consumers) read a version of the resource (e.g., the same version of the resource).

The term incoherent may refer to a situation where two or more consumers read the same resource, and at least one consumer does not read the same version of the resource (e.g., not all of the two or more consumers read the same version of the resource).

The term coherent may refer to a situation where two or more consumers store copies of a resource (e.g., the same resource), and the two or more consumers (e.g., all of the two or more consumers) have a copy of the resource (e.g., an identical copy of the resource).

The term incoherent may refer to a situation where two or more consumers store copies of a resource (e.g., the same resource), and at least one consumer stores a copy of a resource that is not an identical copy of the resource (e.g., not all of the two or more consumers have an identical copy of the resource).

Coherent resource management for associated services may be described herein.

Sets of associated applications and services deployed using multiple application and service providers (e.g., requiring access to coherent copies of a resource to ensure coherent processing results) may not have an application vendor-independent means of managing and maintaining coherent resources. Applications with real-time, high bandwidth, and low latency parameters (e.g., metaverse applications) deployed in devices and networks with limited bandwidth and compute capabilities may not have the means to efficiently maintain coherent resources.

An ASMF, as an enhancement to a network (e.g., the 3GPP core network or service enablement layer) to manage sets of associated services requiring access to coherent copies of a resource may be described herein.

A WTRU (e.g., an enabler client with ASMF-C capabilities) may perform one or more of the following actions as described herein (e.g., to request the creation of a service association (SA) and/or to inform SA members about resource updates).

The WTRU may receive a request to create an SA. The request to create an SA may include at least one of: information about the requestor, information about applications and/or services to include in the SA, information about the coherent resources, or a coherent resource policy (e.g., a request to create a coherent resource policy and/or information associated with a coherent resource policy). The information about applications and/or services may include application identifiers and/or service identifiers. The request to create an SA may be sent from an AC of the WTRU (e.g., via a message or an application programming interface (API)).

The WTRU may send an SA create request to the network. The SA create request may include the information that was received in the request to create an SA and/or information about the WTRU. The SA create request may be sent to a network functional entity with ASMF server component (ASMF-S) capabilities. The functional entity with ASMF-S capabilities may use information to create an SA and/or assign an SA ID (SAID).

The WTRU may receive an SA create response from the network. The SA create response may include a SAID for the newly created SA. The SA create response may include an identifier for the network functional entity with ASMF-S capabilities that created the SA and assigned the SAID. The SA create response may be provided to the ASMF-C of the WTRU. The ASMF-C may store and/or provide the SAID to AC(s) of the WTRU. The AC may store the SAID and/or use the SAID for managing the created SA (e.g., to modify an SA to add/remove application(s) and/or service(s) or delete a SA).

The WTRU may receive a resource update indication. The resource update indication may include at least one of the SAID, information about the requestor, or information about the updated coherent resources. The resource update indication may be sent from an AC of the WTRU. The resource update indication may be indicated to an ASMF-C of the WTRU (e.g., via a message or an API).

The WTRU may send a coherent resource update request to the network. The coherent resource update request may include the information from the resource update indication and/or information about the WTRU. The coherent resource update request may be sent to a network functional entity with ASMF-S capabilities. The functional entity with ASMF-S capabilities may use the provided information to determine the impacted SA members and/or to notify the impacted SA members about the resource update.

The WTRU may receive a coherent resource update response from the network. The coherent resource update response may include the (e.g., updated) coherent resource versions and/or identifiers. The coherent resource update response may be provided to the ASMF-C of the WTRU. The ASMF-C may provide the (e.g., updated) coherent resource versions and/or identifiers to AC(s). The AC(s) may provide the (e.g., updated) coherent resource versions and/or identifiers if/when communicating with an AS that is included in the SA. The AS may use the coherent resource versions and/or identifiers to determine the resource version to use for performing the service request.

A WTRU (e.g., an enabler client with ASMF-C capabilities) may perform the following actions as described herein, to join an SA and/or to handle notifications about coherent resource updates.

The WTRU may receive a request to join an SA. The request to join an SA may include at least one of the SAID of the SA to join, information about the requestor, information about the coherent resources applicable to the requestor, or requestor-specific updates to the coherent resource policy. The request to join an SA may be sent from an AC. The request to join an SA may be indicated to an ASMF-C of the WTRU (e.g., via a message or an API).

The WTRU may send an SA join request to the network. The SA join request may include at least one of the information that was received in the request to join an SA, information about the WTRU, or a notification endpoint. The SA join request may be sent to a network functional entity with ASMF-S capabilities. The functional entity with ASMF-S capabilities may use the received information to add the requestor to the SA and/or to evaluate if/whether the requestor includes coherent resource copies.

The WTRU may receive an SA join response from the network. The SA join response may include a service association member ID (SAMID) for the SA member (e.g., the newly added SA member) and/or information about the coherent resources. The response may be provided to the ASMF-C of the WTRU. The ASMF-C may create a mapping of the SAMID to an AC and/or provide the SAMID to the mapped AC. The AC may use the SAMID in subsequent interactions with the ASMF.

The WTRU may receive a coherent resource update notification from the network. The coherent resource update notification may include at least one of a SAMID, information about the updated coherent resources, or information about where and/or how to retrieve the updated resources (e.g., updated coherent resources). The notification may be provided to the ASMF-C of the WTRU. The ASMF-C may provide the information from the notification to the AC. The AC may use the information from the notification to retrieve a coherent resource based on the information (e.g., based on the provided information).

A network node (e.g., a network functional entity, an application server, or an enabler server with ASMF-S capabilities) may perform the following actions as described herein, to manage SAs and/or to manage coherent resources for ASMF consumers (e.g., WTRUs or other network nodes with ASMF-C capabilities).

The network node may receive an SA create request from an ASMF consumer. The SA create request may include at least one of: information about the requestor, information about the WTRU, information about applications and/or services to include in the SA, information about the coherent resources, or a coherent resource policy. The information about applications and/or services may include application identifiers and/or service identifiers.

The network node may use the information to create a SA. The network node may assign a SAID to the SA (e.g., the network node may assign a SAID to the SA based on the information included in the SA create request).

The network node may send an SA create response to the ASMF consumer. The SA create response may include a SAID for the (e.g., newly) created SA. The ASMF consumer may store the SAID and/or use the SAID for managing the created SA (e.g., to modify an SA to add/remove application(s) and/or service(s), or delete an SA).

The network node may receive an SA join request from the ASMF consumer. In examples, the SA join request may be received from a different ASMF consumer than from the ASMF consumer that requested the creation of the SA. The SA join request may include at least one of: the SAID of the SA to join, information about the requestor, information about the WTRU, a notification endpoint, information about the coherent resources applicable to the requestor, or requestor-specific updates to the coherent resource policy.

The network node may use information (e.g., information associated with the SA join request) to add the requestor to the SA and/or to evaluate if/whether the requestor includes coherent resource copies. The network node may assign a SAMID to the requestor.

The network node may send an SA join response to the ASMF consumer. The response may include a SAMID for the SA member (e.g., the newly added SA member) and/or information about the coherent resources. The ASMF consumer may use the SAMID in (e.g., subsequent) interactions with the ASMF.

The network node may receive a coherent resource update request from the ASMF consumer. In examples, the coherent resource update request may be received from a (e.g., any) SA member with permission to update the coherent resource. The coherent resource update request may include at least one of: the SAID, a SAMID, information about the requestor, information about the WTRU, or information about the updated coherent resources.

The network node may use the information associated with the coherent resource update request (e.g., provided information) to determine the impacted SA members and/or to notify the impacted SA members about the resource update. In examples, the network node may use the information associated with the coherent resource update request (e.g., a coherent resource policy) to determine the impacted SA members and/or to notify the impacted SA members about the resource update.

The network node may send a coherent resource update notification to the impacted ASMF consumers. The coherent resource update notification may include at least one of: a SAMID, information about the updated coherent resources, or information about where and/or how to retrieve the updated resources. The ASMF consumer may use the information from the coherent resource update notification to retrieve a coherent resource.

The network node may send a coherent resource update response to the ASMF consumer (e.g., to the ASMF consumer that sent the coherent resource update request). The coherent resource update response may include the (e.g., updated) coherent resource version(s) and/or identifier(s). The ASMF consumer may provide the (e.g., updated) coherent resource version(s) and/or identifier(s) if/when communicating with an AS (e.g., that may be included in the SA).

Spatial mapping and localization may be described herein.

A spatial map may be a 3D digital model of a physical environment. Spatial mapping may include building a spatial map. Spatial mapping may include collecting and processing sensor measurements at various positions to construct a map of the environment. Spatial mapping may request sensor location information, wireless sensing data, and/or non-3GPP sensor data to create an accurate spatial map of a physical area.

Localization may refer to the position and/or orientation (e.g., pitch, yaw, roll) of an object in a 3D space. Localization of an object may be determined by processing measurements from sensors within visible range of the object (e.g., red/green/blue/depth (RGBD) camera, high-resolution camera), from sensors within wireless range of the object (e.g., Wi-Fi access point, Bluetooth device), and/or from sensors attached to the object itself (e.g., gyroscope, accelerometer, magnetometer, global positioning system (GPS), RGBD camera, high-resolution camera, Wi-Fi, Bluetooth). Localization may be determined by comparing sensor measurements with mapped measurements stored in a spatial map of the environment. Localization accuracy may vary depending on the type of sensors used to obtain measurements, and on the accuracy and latency of the measurements used to calculate localization.

Spatial anchors may be described herein.

Localized user experiences may occur in the user's local environment. Such experiences may request that the metaverse media (e.g., virtual information) provided to a user is adapted and/or integrated with the local physical world surrounding the user.

A localized mobile metaverse service may be associated with specific places (e.g., 3D locations in the physical world). The association between a physical place and service information (e.g., an associated service) may be a localized spatial anchor.

A localized mobile metaverse service may allow third parties to provision localized spatial anchors via a service offered by the mobile network, and may allow mobile network users to discover the provisioned localized spatial anchors for the purpose of displaying the media associated with the localized spatial anchor.

Extended reality (XR) and metaverse use cases may request real-time data processing and computing across a diverse set of devices. For example, augmented reality (AR) rendering may be performed on a WTRU or at the network edge, depending on the computing capabilities of the WTRU and capabilities of the network nodes. In examples, spatial computing functions (e.g., WTRU localization, spatial mapping, object tracking, etc.) may be performed by service(s) across devices and networks.

Applications on a WTRU with limited compute capabilities may request (e.g., several) network service(s) to execute tasks on its behalf. In examples, services may need to perform operations on the same set of resources. A resource may include information or data maintained by a service. Resource types may vary depending on the service type. Resources may be accessed using an API provided by a service and may be copied and used by other applications and services. Depending on the requested service operations and the type of resource, copies of a resource stored in a (e.g., each) service may be coherent to ensure coherent output from the related service operations. Related services may be referred to as associated services. For example, associated services such as a spatial localization service and/or a spatial anchor service may request a spatial map (e.g., 3D model or XR spatial description of the physical environment) to determine a precise WTRU position and orientation in space, or to determine the spatial anchors of interest that are visible to a WTRU. Services may operate on equivalent copies of a spatial map to provide coherent results to the requesting WTRU applications. For example, WTRU localization and spatial anchor services operating on different copies of a spatial map may lead to an incoherent output at the WTRU, causing an AR application to incorrectly render spatial anchor virtual content (e.g., in an incorrect position, in front of obstructing objects, etc.).

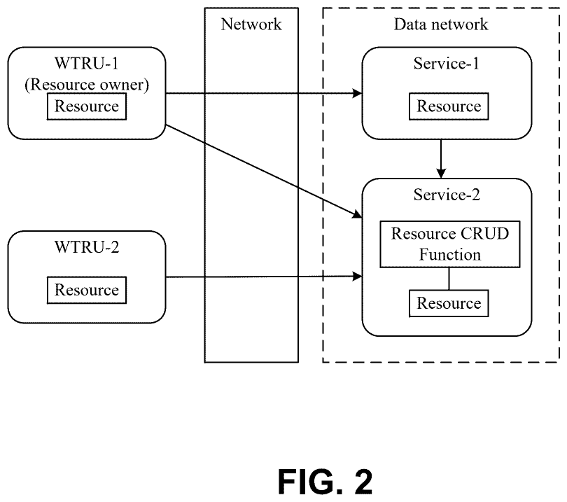

A resource may be stored in a (e.g., one) location (e.g., WTRU, network node, database, etc.) and may include (e.g., several) copies in other locations. FIG. 2 illustrates an example distributed system deployment where (e.g., several) copies of a resource exist in one or more (e.g., different) locations.

Copies of a resource may differ depending on the update and/or synchronization frequency at a (e.g., each) location. For example, a locally updated resource in a WTRU may differ from its backend copy stored in a network server (e.g., at least until the WTRU provides the resource updates to the network server). The backend server copy of a resource may include updates that have not been propagated to or retrieved by other network services or WTRUs requiring the resource.

Differing copies or versions of a resource may be tolerable for applications and/or services that have the bandwidth, computing capabilities, and/or time to maintain equivalent copies of a resource in locations (e.g., all locations where it is required). For example, a WTRU-owned resource, which may be small (e.g., a few bytes of data), may be included in a (e.g., each) service API invocation of different network service(s) (e.g., without impacting performance and/or to ensure (e.g., guarantee) that the services operate on the same copy of the resource).

There may be examples where resource size and/or update frequency have an impact (e.g., a significant impact) on available bandwidth, compute, and/or latency. For example, if the resource is large (e.g., a spatial map with hundreds of megabytes of data), the resource may not be included in a service (e.g., each service API invocation) because the resource would have adverse effects on available bandwidth and/or latency. In examples where a resource is large, it may be advantageous to reduce the amount of bandwidth used for propagating resource updates or to keep the frequency of resource updates to a minimum while maintaining equivalent copies of a resource if/when requested. For example, a WTRU may use different services such as spatial computing services and/or a spatial anchor service that may operate on a spatial map (e.g., the same spatial map). The WTRU may update the local copy of the spatial map resource frequently based on WTRU sensor input. The WTRU may provide updates to the WTRU localization and/or spatial anchor services to ensure (e.g., make sure that) the service operations output of services (e.g., both these services) remains coherent. Transferring the spatial map to a service (e.g., both services) at a frequent rate may have a negative effect on available bandwidth and/or latency.

Enhancements to a network may be described herein.

A system (e.g., a 5G system) may provide operations for a WTRU, network applications, and/or services to discover, establish connectivity with, and/or obtain permission to access service APIs. A system (e.g., a 5G system) may allow an AF to configure traffic flows for application layer sessions and/or provide a common and vertical-specific enablement layer service to the application layer.

Network functions and/or service enablers (e.g., spatial anchor management, spatial mapping and localization, spatial computing, etc.) may be defined to enable metaverse applications. Functions and/or services may be fundamental to enabling classes of devices (e.g., lightweight AR glasses, VR headsets, etc.) that include limited processing capabilities and request low latency.

Systems, methods, and apparatuses for consuming shared resources coherently in real-time environments and across bandwidth-limited networks (e.g., among sets of associated WTRUs and/or services) may be described. Features described herein may enable a set of associated applications and/or services that operate (e.g., are required to operate) on similar (e.g., equivalent) copies of a resource to efficiently operate coherently and in a timely manner.

Enhancements to enable a consumer application (e.g., an AC on a WTRU or an AS in a DN) to manage and maintain coherent resources for a set of associated applications and/or services may be described herein. Enhancements may allow the consumer application to indicate (e.g., via policy) the conditions under which the associated applications and/or services may be notified about available resource updates.

Enabling deployments to efficiently coordinate and manage real-time access to resources for sets of related services may be described herein. An ASMF may be an enhancement to the network (e.g., the 3GPP core network) or a service enablement layer (e.g., to manage sets of associated services requiring access to resources coherently).

An AC may be a user application that is included as part of a WTRU. An AC may communicate with an AS. A WTRU may use (e.g., several) AC(s) concurrently.

An AS may be an application server that is included as part of a DN. An AS may be a software server executing on (e.g., generic) hardware. An AS may provide a service to an AC or to another AS. An AS may serve one or more AC instances that may be included as part of a (e.g., different) WTRU(s) and/or one or more AS instances that may be included as part of a DN.

An enabler client (EC) may be a service enabler that is included as part of a WTRU. An EC may communicate with an ES. An EC may provide client-side functionalities to AC(s) (e.g., for a specific enablement service).

An enabler server(ES) may be a service enabler that is included as part of a DN. An ES may provide server-side functionalities to AS(s) (e.g., for a specific enablement service). An ES may serve one or more EC instances that may be included as part of one or more WTRU(s) (e.g., that may reside on different WTRUs), and/or may serve one or more ES instances (e.g., with client-side functionalities) that may be included as part of a DN.

Requestor information may be information that characterizes a requestor. Requestor information may include at least one of: a user identifier (e.g., a unique ID), an AC or AS identifier (e.g., unique ID), an AC or AS type, security credentials, or a notification endpoint.

WTRU information may be information that characterizes a WTRU. WTRU information may include at least one of: a WTRU identifier (e.g., SUPI, GPSI, phone number, and/or the like), a WTRU state, and/or WTRU capabilities such as supported RAT(s), processing capabilities (e.g., CPU, GPU), or artificial intelligence/machine learning (AIML) processing capabilities.

A WTRU state may represent information about the WTRU that characterizes a device state. A WTRU state may include a power state (e.g., a battery level), and/or a connection state (e.g., signal quality, RAT, and/or the like).

Associated service information may be information that characterizes a set of related applications and/or services. Associated service information may include at least one of: an application group identifier (e.g., a unique application-layer identifier), application identifiers and/or service identifiers (e.g., unique application-layer identifiers for application and/or service types or for application or service instances), group roles (e.g., creator, writer, reader) specifying instance functionality or application and/or service inter-dependencies (e.g., dependencies between application and service instances).

Resource information may be information that characterizes a resource. Resource information may include at least one of: a resource identifier (e.g., URI), a resource type, a resource location, a resource size, a resource version (e.g., version number, version string, timestamp), a resource filter, or resource access credentials (e.g., for authorized applications and/or services to retrieve the resource). A resource filter may identify matching resources. Resource filters may include resource information elements (e.g., any of the resource information elements).

An SA may be a group of related applications and/or services that operate on coherent copies of one or more resources to produce coherent operation results. An SA may include at least one of: associated service information (e.g., for the applications and/or services that are allowed to join the SA), resource information (e.g., for resources that (e.g., must) remain coherent within the SA), or a coherent resource policy (e.g., for determining how to detect and maintain coherent resources). An SA may be valid for a period (e.g., a specified period such as a date, time, and/or the like), may be valid in a (e.g., specified) location, and/or may be valid if/when a (e.g., specified) number of applications and/or services have joined the SA. An SA that is not valid may be removed until the validity condition(s) are met (e.g., at which time, the SA may be added again).

Resource coherence may be a state indicating that information that is distributed on systems (e.g., different systems such as distributed resources) is the same and/or similar. A distributed resource may be coherent if/when copies of that resource, present on different systems, is the same and/or similar. A coherent resource that is processed by services (e.g., different services) that may be part of an SA may produce coherent outputs from those services. Resource coherence may be determined based on condition(s) (e.g., specified in a coherent resource policy). A coherent resource may be a resource that meets the resource coherence condition(s). An incoherent resource may be a resource that does not meet the resource coherence condition(s).

A coherent resource policy may be a policy that provides (e.g., specifies) rule(s) for determining resource coherence and/or action(s) for maintaining coherent resources within an SA. Policy rules may include SA condition(s) for detecting incoherent resources and/or for triggering actions (e.g., the necessary actions) to make the resources coherent. Policy rules may be based on at least one of: resource coherence conditions such as a resource type, a resource version, resource information layers (e.g., resource type-specific layers of information), resource synchronization thresholds (e.g., thresholds specifying the maximum difference between versions or update times of distributed resource copies), resource consumer type (e.g., application, service), resource consumer inter-dependencies (e.g., minimum number of consumers for a coherent resource, dependencies between consumer instances), resource consumer state (e.g., application in foreground or background), expected resource usage (e.g., resource consumption frequency), time (e.g., time of day, time of last resource update), location (e.g., WTRU location, predicted WTRU location), or application layer conditions. Policy actions may include sending updated resource information or sending a notification indicating a request to retrieve an updated version of a resource (e.g., to the applications and/or services with resource copies determined to be incoherent). Policy actions may include removing a coherent resource from the SA.

A spatial compute service may be a service with spatial computing capabilities that support operations (e.g., such as spatial mapping and localization). A spatial compute service may own, or may have access to, a spatial map of a physical environment.

An ASMF may be described herein. Enhancements to a service enablement layer or a network (e.g., the 3GPP service enablement layer and/or 5G core network), to enable the management of SA(s) requesting coherent copies of a resource may be described herein. For example, enhancements may include a functionality for creating or joining SAs, or for determining if/when to notify and/or retrieve resource updates. Enhancements may be included in an ASMF, as described herein.

In a system (e.g., a 3GPP system), an ASMF may provide services to applications on a WTRU (e.g., AC) and/or in a network (e.g., AS). The ASMF may create SAs. The ASMF may offer capabilities to manage SAs. The ASMF may store information related to a managed SA and/or information about the resources included in (e.g., required by) a SA. The ASMF may perform processing related to the management of SAs and/or related to maintaining coherent copies of a resource. The ASMF may enable concurrent management of SAs and may offer the ASMF service to one or more concurrent consumers.

Deployment options may be described herein. The ASMF may offer a service to manage SAs requesting coherent copies of a resource. The service may be offered to a consumer (e.g., via an API). The ASMF functionality may be implemented as a standalone AF or as a network function (NF). The ASMF functionality may be included (e.g., combined) with an existing AF or NF. The API may be offered as an extension of an existing API, and/or the API may be based on a non-access stratum (NAS) interface or a service-based interface.

The ASMF service may be offered using a communication protocol. For example, the Hyper Text Transfer Protocol (HTTP) or the NAS protocol (e.g., for 5G systems) may provide access to the capabilities of the ASMF service.

The ASMF may follow a client-server model by splitting the ASMF into client and server components. The ASMF client component (ASMF-C) may be located on a WTRU (e.g., a terminal component) or in the network (e.g., a AS or network component). A consumer AC on a WTRU or a consumer AS in the network, may use the ASMF functionality provided by the ASMF-C. The ASMF-S may be accessible via (e.g., or located within) a network. An AS, AF or NF in the network may offer the ASMF functionality provided by the ASMF-S. The ASMF-C and/or ASMF-S may (e.g., together) provide ASMF services to applications.

The ASMF functionality may be packaged in a library that is statically linked with an AC or AS, or dynamically loaded by an AC or AS. An ASMF may be deployed as a function element (e.g., may be alternatively deployed as a standalone functional element) in a WTRU or in a DN. For example, the ASMF may be deployed as an EC on a WTRU and as an ES in a DN. The AC and AS may, respectively, access functionality provided by the EC and ES (e.g., via a determined API or interface).

The ASMF-C may (e.g., alternatively) be deployed in an EC that is not included as part of the same WTRU as the AC. For example, an AC deployed on terminal equipment (TE) may use AT commands to interact with an EC deployed in the mobile termination (MT) part of the WTRU. For example, an AC deployed on a TE may interact with an EC that is (e.g., also) deployed in the TE part of the WTRU. For example, an AC may use a tethered connection (e.g., a D2D connection such as Bluetooth, WiFi, or PC5) to communicate with an EC that runs in the WTRU. Combinations of the deployments described herein are possible.

Creating an SA may be described herein. The ASMF API may provide create, read, update, delete (CRUD) functionality for managing a SA. The ASMF may allow an ASMF consumer (e.g., an AC on a WTRU, or an AS in a DN) to manage the lifecycle of a SA. The ASMF consumer may at least one of: determine (e.g., at the application layer) that an application or service (e.g., for a set of applications and services) may use (e.g., may need) coherent copies of a resource, create a coherent resource policy to ensure that resources remain coherent across applications and/or services, or request the creation of an SA to enforce the policy. The consumer may send a request to update the SA if there is a change to be applied (e.g., if there is an update to a resource, a SA, a coherent resource policy, requestor information, resource information, WTRU information, associated service information, and/or the like). If/when the applications and/or services no longer request coherent copies of a resource, the consumer may request to delete the SA.

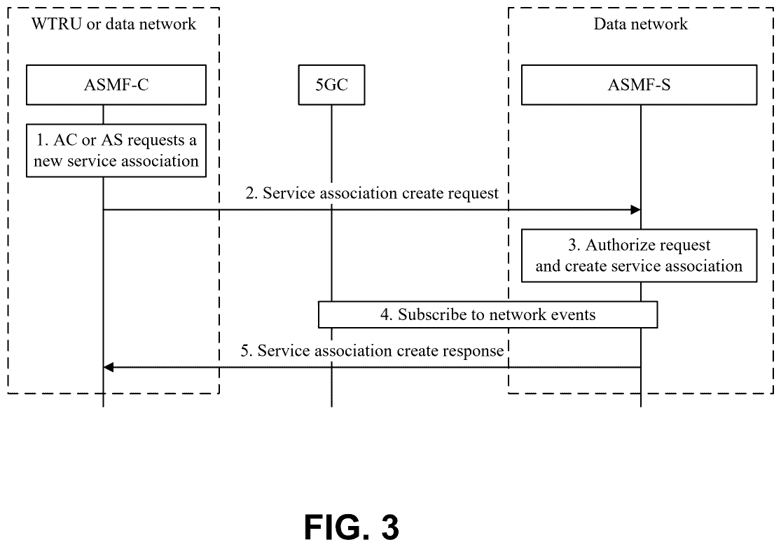

FIG. 3 illustrates an example operation for creating a SA. Similar request-response operations may apply for the (e.g., remaining) CRUD operations.

At 1, the consumer (e.g., an AC on a WTRU, or an AS in a DN) may determine to create and/or manage an SA (e.g., the consumer may determine an application layer need for a set of applications and/or services, which may use coherent copies of one or more resources. Based on the determination to create an SA, the consumer may send a request to the ASMF-C, to create a (e.g., new) SA. The request may include at least one of: requestor information, associated service information (e.g., for the applications and/or services that are allowed to join the SA), resource information (e.g., for resources that are (e.g., must remain) coherent within the SA), or a coherent resource policy (e.g., a coherent resource policy outlining the rules to be enforced to maintain coherent resources and/or coherent resource policy information that may be used to generate a coherent resource policy).

For example, an AR application on a WTRU (e.g., with limited compute and bandwidth capabilities) may use a spatial mapping service to store a WTRU-specific instance of a spatial map, may use a spatial localization service to calculate precise WTRU localization, and/or may use a spatial anchor service to obtain localized spatial anchor information of interest. A service instance (e.g., each service instance) may perform calculations using a coherent WTRU spatial map. To ensure proper rendering in the AR application, services may operate on coherent versions (e.g., it may be requested that all services operate on coherent versions) of the WTRU spatial map. For example, the AR application may use the spatial map to perform rendering, and the spatial localization service may use the spatial map to (e.g., precisely) localize the WTRU in a physical environment. The rendering service and/or localization service may have a dependency (e.g., a strong dependency) on using a coherent WTRU spatial map to provide coherent results. Based on these application and/or service conditions, the AR application may request a WTRU-specific spatial map from the spatial mapping service, create a coherent resource policy, and/or send a request to the ASMF to create an SA (e.g., to efficiently manage updates to the spatial map). The request may include at least one of: information about the applications and/or services to include in the SA, information about how to access the spatial map resource, or the coherent resource policy.

In examples, associated services may not request (e.g., require) identical versions of a resource to produce a coherent output. For example, a spatial anchor service may not request (e.g., require) the same level of accuracy as a localization service to identify spatial anchors of interest to a WTRU. A spatial map may include layers for static and for dynamic objects. The spatial anchor service may provide coherent results without the latest information about dynamic objects. The spatial anchor service may request (e.g., additionally only require) a spatial map for indoor environments or based on a WTRU location. In examples, an AR application requesting (e.g., requiring) ASMF capabilities may create and/or provide a coherent resource policy with resource coherence rules based on updates to (e.g., specific) resource layer information.

At 2, the ASMF-C may send an SA create request to the ASMF-S. The SA create request may include at least one of: an ASMF-C identifier, security credentials, a notification endpoint, WTRU information, or information received in the request from the ASMF consumer. For example, the ASMF-C may provide the requested SA information to the ASMF-S with (e.g., additional) information about the requesting WTRU. For example, the WTRU information may be used to register for network events (e.g., 3GPP core network events). An example of WTRU information may be an external identifier of the WTRU. The external identifier of the WTRU may be used by the ASMF-S to subscribe to event notifications from the NEF related to the WTRU.

At 3, the ASMF-S may verify the request information (e.g., security credentials, requestor information, and/or the like) and/or determine if/whether the requestor is authorized to create an SA. If ASMF-S authorizes the request information, the ASMF-S may create an SA instance and/or store the SA information received in the request. Otherwise, the ASMF-S may indicate an error in the response (e.g., if the ASMF-S determines not to create the SA based on the request information). For example, the ASMF-S may store the SA information in a local database.

Authorization of the request may be based on the ASMF-S sending a request to an authorization function. The request may include at least one of: the application identifiers, service identifiers, or resource identifiers that the ASMF-C requests to associate. The authorization function may reply with an indication of if/whether the applications, services, and/or resources may be allowed to be associated. The authorization function may be an NEF.

The ASMF-S may use the group roles from the received associated services information to determine an instance (e.g., application or service instance) (e.g., specific) access permissions for ASMF operations. Based on the requested role, a subset (e.g., only a subset) of ASMF capabilities may be included (e.g., required). For example, an application and/or service in the SA may be authorized to update and/or delete a SA, while other applications and/or services in the SA may be (e.g., may only be) allowed to join a SA.

The ASMF-S may use the resource filters from the received associated services information and/or resource information to identify matching resources and/or to create a list of resources that are part of the SA. For example, the ASMF-S may create a list of resources that are associated with the application identifiers and/or service identifiers that were received in the request from the ASMF-C. In examples, the ASMF-S may determine the resources to include in the SA based on a resource type and/or location provided in the resource filters.

The ASMF-S may use the received coherent resource policy to create a resource update configuration for a (e.g., each) SA member. The resource update configuration may be used by the SA members to determine if/when a locally detected resource update (e.g., detected by the SA member) may be provided to the ASMF-S. For example, a coherent resource policy may specify a time-based synchronization threshold for a WTRU (e.g., with sensing capabilities to update a resource and/or inform the ASMF-S about the updated resource). The ASMF-S may create and/or provision a resource update configuration in the WTRU (e.g., to indicate if/when the ASMF-S expects to receive resource updates).

At 4, the ASMF-S may subscribe to network events (e.g., 3GPP core network events) based on information received in the SA create request. For example, the ASMF-S may determine, (e.g., based on the coherent resource policy), that an AC on a WTRU will (e.g., only) use a (e.g., specific) service if/when the service is within a designated location. In examples, the ASMF-S may request WTRU location updates from the network (e.g., the core network using the WTRU information) to obtain the WTRU location information (e.g., required) to determine resource coherence. The ASMF-S may use an API (e.g., may invoke 5GC network APIs (e.g., via the NEF)) and/or may subscribe for events such as WTRU mobility events, WTRU location change events (e.g., by sending a request to the LMS or SEAL-LMS), and/or predicted WTRU location (e.g., by sending a request to the NWDAF).

At 5, the ASMF-S may send an SA create response to the ASMF-C. The response may include an indication indicating if/whether the SA was successfully created, indicating the authorized ASMF operations for the requestor, and/or indicating a SAID (e.g., that may be used during subsequent calls to the ASMF-S to identify the stored SA information). The response may include the resource information for the coherent resources associated with the SA. For example, the ASMF consumer may include the SAID in a request to update or delete a SA, or another ASMF consumer may include the SAID in a request to join or leave a SA.

If the ASMF-S created a list of resources that are part of the SA, then the ASMF-S may include the list of resources in the SA create response.

If the ASMF-S created a resource update configuration for the requestor, then the ASMF-S may include the resource update configuration in the SA create response.

The ASMF-S, (e.g., based on creating the SA at 3), may notify subscribers for the creation of a (e.g., new) SA. A subscriber for a (e.g., new) SA may be an AF, a NF, or a WTRU. The subscription for a (e.g., new) SA may include a filter. The filter may include information about the WTRU, information about the applications and/or services included in the SA, or a notification endpoint. For example, an ASMF-S may create an SA including a first and/or a second service. The ASMF-S may determine that an AF has subscribed to be notified for a (e.g., new) SA that includes the first service and may notify the AF of the SA creation based on the SA including the first service. The notification message may include information about the SA (e.g., any information included in the SA create response as described at 5). The notification message may be sent to the notification endpoint (e.g., indicated in the subscription).

Joining an SA may be described herein. The ASMF may support membership operation(s) for SAs. A membership operation may allow an ASMF consumer (e.g., an AC on a WTRU or an AS in a DN) to join or leave a SA. The consumer may at least one of: determine whether/if an application layer may use coherent copies of a resource, obtain the (e.g., necessary) identifiers and/or credentials (e.g., via application layer communication with the ASMF consumer that created the SA), or request to join a SA. The consumer may provide consumer information (e.g., additional consumer-specific information) to include in the policy to be enforced by the ASMF. If/when the consumer no longer requires the resource, the consumer may request to leave the SA.

The validity of an SA may depend on the SA members. For example, an SA may include an application and/or service(s) that are inter-dependent and/or that may (e.g., must) be members for the SA to be valid.

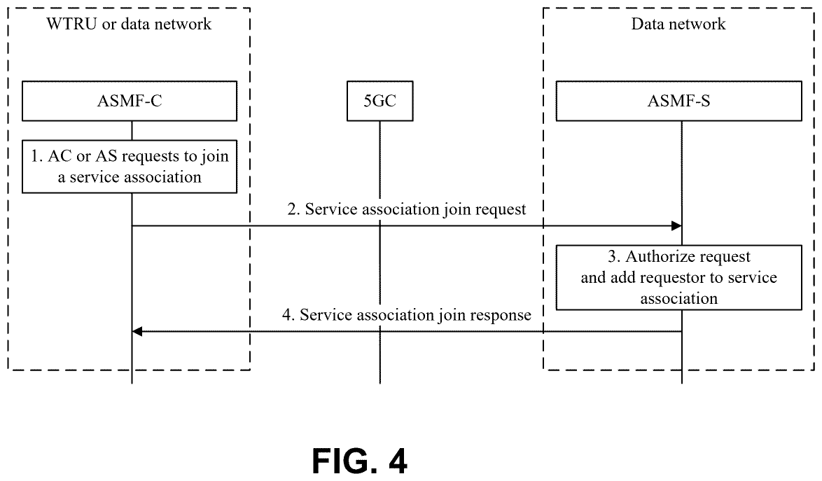

FIG. 4 illustrates an example operation for joining a SA. A similar request-response operation may apply for leaving a SA.

In examples, an ASMF consumer (e.g., an AC on a WTRU or an AS in a DN) may successfully create an SA as shown in FIG. 3 as a prerequisite to joining the SA.

At 1, the consumer (e.g., an AC on a WTRU or an AS in a DN) may determine (e.g., at an application layer) to join an SA (e.g., the consumer may determine an application layer need to join an SA). The consumer may obtain the SAID of the SA it requests (e.g., wishes) to join (e.g., by communicating with the application that created the SA). For example, an application that creates an SA and requests (e.g., wishes) to use services from an AS that may operate on a coherent resource copy may include the SAID in a service request to the AS.

Based on the determination that the consumer requests (e.g., wishes) to join a SA, the consumer may send a request to the ASMF-C to join the SA. The request may include at least one of a SAID, requestor information, an application group identifier (e.g., a unique application-layer identifier to identify a set of associated applications and services), resource information (e.g., indicating the versions of the resource copies stored by the consumer and/or indicating details about a (e.g., any) resources owned by the consumer), or updates to the coherent resource policy (e.g., consumer-specific updates to the coherent resource policy).

For example, an AR application on a WTRU (e.g., with limited compute and bandwidth capabilities) may use a spatial mapping service to store a WTRU-specific instance of a spatial map, may use a spatial localization service to calculate precise WTRU localization, and/or may use a spatial anchor service to obtain localized spatial anchor information of interest. The AR application may request that the ASMF create an SA (e.g., to manage the WTRU-specific spatial map), The AR application may obtain a SAID from the ASMF for the (e.g., newly) created SA. The AR application may provide the SAID to the spatial localization and/or spatial anchor services to allow the spatial localization and/or spatial anchor services to join the SA. The spatial localization service may send a request to the ASMF to join the SA. The request may include the SAID provided by the AR application, instance specific service information, and/or the current version of the spatial map copy in the service. The spatial anchor service may (e.g., also) send a request to the ASMF to join the SA. The request may include the SAID provided by the AR application, instance specific service information, the current spatial map version identifier, and/or a service-specific condition for monitoring the WTRU location and/or mobility events.

At 2, the ASMF-C may send an SA join request to the ASMF-S. The SA join request may include at least one of: an ASMF-C identifier, a notification endpoint, WTRU information, or (e.g., any) information received in the request from the consumer (e.g., the SA join request).

At 3, the ASMF-S may verify the request information (e.g., SAID, security credentials, requestor information, and/or the like) and/or determine if/whether the requestor is authorized to join a SA. If authorized, the ASMF-S may add the requestor to the SA instance and/or store the consumer-specific information received in the request. Otherwise, the ASMF-S may indicate an error in the response (e.g., if the requestor is not authorized to join the SA). For example, the ASMF-S may store the SA information in a local database.

The ASMF-S may (e.g., additionally) verify, based on the request information and/or on the coherent resource policy of the SA, if/whether the resource copies stored in the consumer are coherent. For example, the ASMF-S may compare the resource versions provided by the consumer with the resource versions of the SA, and determine that the consumer resource copies are incoherent (e.g., the resource version provided by the consumer does not match the resource version of the SA). The ASMF-S may include an indication of resource coherence in the response or may send a notification to the ASMF-C.

At 4, the ASMF-S may send an SA join response to the ASMF-C. The SA join response may include an indication indicating if/whether the requestor was successfully added to the SA and/or a (e.g., unique) SAMID. The SAMID may be used (e.g., by the requestor) during subsequent calls to the ASMF-S to identify the stored consumer-specific service association information. The SA join response may (e.g., further) include the coherent resource associated with the SA (e.g., the SA join response may include an indication of a resource associated with the SA). For example, the consumer may include the SAMID in a request to leave a SA.

If the ASMF-S created a list of resources that are part of the SA, then the ASMF-S may include the list of resources in the SA join response. In examples, the join operation (e.g., as illustrated in FIG. 4) may be used (e.g., by an ASMF-C) to discover what resources are related to a SAID (e.g., a requestor may use the join operation to discover a coherent resource associated with a SA).

If the ASMF-S created a resource update configuration for the requestor, then the ASMF-S may include the resource update configuration in the SA join response.

The ASMF-S, based on updating the SA at 3, may notify subscribers for SA updates. A subscriber for SA updates may be an AF, a NF, or a WTRU. The subscription for (e.g., new) an SA may include a filter. The filter may include information about the WTRU and/or applications, services included in the SA, and/or a notification endpoint. For example, an ASMF-S may update an SA to include a first service. The ASMF-S may determine that an AF has subscribed to be notified for SA updates (e.g., that includes the first service) and may notify the AF of the SA update based on the SA including the first service. The notification message may include information about the SA (e.g., such as (e.g., any of the) information included in the SA join response as described at 4). The notification message may be sent to the notification endpoint indicated in the subscription.

Managing coherent resources may be described herein. The ASMF may support coherent resource management operations. Operations may allow an ASMF consumer (e.g., an AC on a WTRU or an AS in a DN) to inform the ASMF about changes to a coherent resource in the SA. The consumer may determine (e.g., at the application layer), that a resource has been updated, and the consumer may inform the ASMF about the update. The ASMF may receive a notification (e.g., a WTRU location change event) from the network (e.g., 3GPP core network) with information impacting resource coherence. Based on the information received from the consumer or the network (e.g., 3GPP core network), the ASMF may use the coherent resource policy to evaluate resource coherence and/or to determine an action (e.g., required) to maintain coherent resources. For example, the ASMF may send resource update notification(s) to SA services that have been determined to include an incoherent resource copy. The impacted services may (e.g., then) retrieve the (e.g., required) resource version (e.g., to make sure the services generate coherent results when processing subsequent service requests).

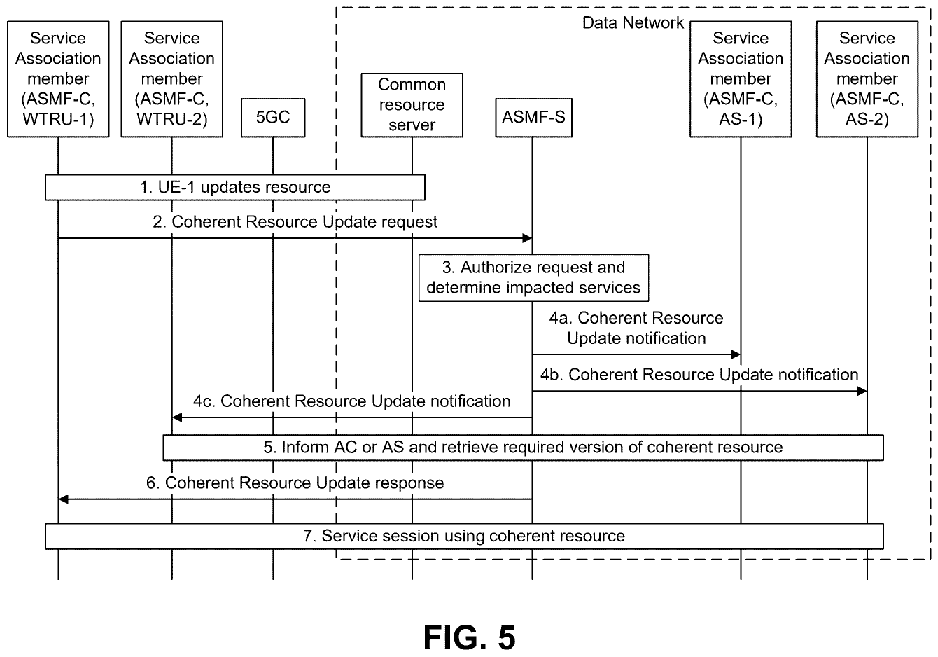

FIG. 5 illustrates an example operation for updating a coherent resource for a SA. In examples, an ASMF consumer (e.g., an AC on a WTRU or an AS in a DN) may have successfully created an SA as shown in FIG. 3, and SA members may have successfully joined the SA as shown in FIG. 4 (e.g., as a prerequisite to the example for updating a coherent resource for a SA).

At 1, an ASMF consumer (e.g., an AC on a WTRU) may determine that a coherent resource has been updated. The consumer may determine that a coherent resource has been updated based on application layer information and/or messaging. For example, the consumer may be an AC on a WTRU that is the resource owner of a spatial map stored in a common resource server (e.g., a network database). The consumer may process local sensor data to update a local copy of the spatial map and may push the update to the common resource server (e.g., via the 3GPP core network such as 5GC). The consumer may request (e.g., wish) to inform a member (e.g., some members) of an SA (e.g., a spatial localization service and/or a spatial anchor service) that the member may retrieve (e.g., fetch) the latest version of the spatial map (e.g., to make sure (e.g., all) members are operating on the same resource version). In examples, the consumer may monitor updates to a resource stored in a common resource server (e.g., a network database) and may wish to inform other consumers about the update (e.g., the update to the resource). The consumer may send a request to the ASMF to determine (e.g., based on the coherent resource policy) which members of the SA may (e.g., must) be notified about a resource update.

The common resource server and the ASMF-S may be co-located on the same server. Although not shown in FIG. 5, the ASMF consumer may be an AS in a DN with permission to update a resource in the common resource server (e.g., in which case the description at 2 may be triggered by a network functional entity with ASMF-C capabilities).

Based on the determination that a coherent resource has been updated, the consumer may send a request to the ASMF-C (e.g., to notify an SA about changes to a coherent resource). The request may include at least one of: information about an SA (e.g., SAID, SAMID, and/or the like), requestor information, or resource information (e.g., indicating the versions or timestamps for the updated coherent resource).

For example, an AR application (e.g., on a WTRU with limited compute and bandwidth capabilities) may use a spatial mapping service to store a WTRU-specific instance of a spatial map, may use a spatial localization service to calculate precise WTRU localization, and/or may use a spatial anchor service to obtain localized spatial anchor information of interest. The AR application may have created an SA, and/or the spatial localization and/or spatial anchor services may have joined the SA. The AR application may obtain WTRU sensor input and/or request a spatial map update from the spatial mapping service (e.g., a common resource server). The AR application may notify the ASMF about the updated spatial map (e.g., to ensure that the SA members operate on a coherent copy of the spatial map). The ASMF may determine to notify the spatial localization service about the spatial map update, whereas the ASMF may determine not to notify the spatial anchor service about the latest version of the spatial map (e.g., the ASMF may determine that the spatial anchor service may generate a coherent output without the spatial map update, and the spatial localization service may not generate a coherent output without the spatial map update). In examples, benefits of using the ASMF to manage spatial map updates may include bandwidth savings on the WTRU and in the network (e.g., by limiting the number of times the spatial map is copied and transferred), as well as service request latency improvements (e.g., by actively pushing spatial map updates to services before they are required).

At 2, the ASMF-C may send a coherent resource update request to the ASMF-S. The coherent resource update request may include at least one of: an ASMF-C identifier, WTRU information, or (e.g., any) information received in the request from the consumer.

Although not shown in FIG. 5, an AC on a WTRU may provide the SAID to the common resource server (e.g., to allow the common resource server to send a coherent resource update request to the ASMF). In examples, the common resource server may include ASMF-C capabilities.

At 3, the ASMF-S may verify the request information (e.g., SAID, SAMID, security credentials, requestor information, and/or the like) and/or determine if/whether the requestor is authorized to indicate resource updates to a SA. In examples, the ASMF-S may create an SA using the SA information provided by the requestor. In examples, the ASMF APIs may allow the requestor or consumer to inform the ASMF about coherent resource updates for a (e.g., specific) SA (e.g., identified using SAID and/or SAMID). If authorized, the ASMF-S may determine (e.g., based on the request information and/or based on the coherent resource policy of the SA) which member(s) of the SA include an incoherent resource copy and may (e.g., must) be notified about a resource update. Otherwise, the ASMF-S may indicate an error in the response (e.g., if the ASMF-S determines that the requestor is not authorized to update the SA).

For example, the ASMF-S may determine to notify a spatial localization service about a spatial map update, whereas the ASMF-S may determine not to notify a spatial anchor service about the latest version of a spatial map (e.g., the ASMF-S may determine that the spatial anchor service may generate a coherent output without the spatial map update and that the spatial localization service may generate an incoherent output without the spatial map update).

If the ASMF-S has subscribed for network events (e.g., 3GPP core network events), the ASMF may receive a notification from the network (e.g., 3GPP core network) with information that may impact resource coherence. For example, a notification from the NEF that indicates a WTRU mobility event or predicted WTRU location change may trigger the ASMF to evaluate resource coherence and/or to determine if/whether a (e.g., any) of the SA members may be notified about a resource change.

The request may be a (e.g., any) request that indicates a property of the ASMF-C (e.g., or a property of the WTRU that hosts the ASMF-C). The ASMF-S may evaluate the property of the ASMF-C (e.g., or of the WTRU) and, based on the property, determine that one or more resources that are associated with the SAID are (e.g., now) considered incoherent. Examples of a property of the ASMF-C (e.g., or the WTRU that hosts the ASMF-C) may include location, speed, roaming status, and/or if/whether usage of a particular RAT is available to the ASMF-C (e.g., or WTRU).

At 4, the ASMF-S may send a coherent resource update notification to the ASMF-C, including a (e.g., each) SA member requesting (e.g., requiring) a resource update (e.g., the coherent resource update notification may be sent to each ASMF-C, wherein each AMSF-C is associated with (e.g., provides service to) an SA member that requests a resource update). The ASMF-S may send the notification to the notification endpoint of the ASMF-C (e.g., provided when a member joins a SA). The notification may include a target SAMID, resource information for the resources determined to be incoherent, and/or updated resource information. For example, the ASMF-S may provide the resource URI, version, and/or credentials for a resource to retrieve (e.g., to make sure that the resource is coherent).

At 5, the ASMF-C may inform the target SA member (e.g., an AC on a WTRU or an AS in a DN) that the SA member may update its resource copy (e.g., to make sure the resource remains coherent). The ASMF-C may provide, to the target SA member (e.g., any) information received in the coherent resource update notification. The SA member may use the information received in the coherent resource update notification to retrieve the (e.g., required) resource version to maintain a coherent resource. For example, the ASMF-C may notify an AR rendering application on a WTRU that the AR rendering application may use the provided credentials and/or URI to obtain a version (e.g., the latest version) of a spatial map (e.g., that includes updates based on sensing data from another WTRU in the area). In examples, the ASMF-C may inform a spatial anchor service in the network that the spatial anchor service may update its local copy of a coherent resource using the provided resource update information.

At 6, the ASMF-S may send a coherent resource update response to the ASMF-C (e.g., the ASMF-C of the ASMF consumer that reported a coherent resource update). The response may include an indication indicating if/whether the request was successfully processed and/or if/whether the impacted SA members were successfully notified. The response may (e.g., also) include resource information (e.g., indicating the updated versions to be used for coherent resources).

In examples, coherent resource update requests may be received simultaneously (e.g., one or more resource writers update the same resource and inform the ASMF at the same time). If the coherent resource update requests are received simultaneously, the ASMF-S may evaluate (e.g., all) resource updates before sending a coherent resource update response (e.g., and makes sure to provide the latest coherent resource information in the responses). The ASMF-S may resend the coherent resource update notification(s) to SA members that do not have the latest coherent resource information.

At 7, the ASMF-C may inform the ASMF consumer that the coherent resource was successfully updated. The ASMF-C may provide, to the consumer, (e.g., any) information received in the coherent resource update response. The consumer may use the coherent resource update response information during (e.g., subsequent) service calls to SA members (e.g., to make sure all applications and/or services operate on coherent resource copies). For example, the ASMF-C may provide an updated spatial map version identifier to the AR rendering application. The AR rendering application may include a version identifier in a (e.g., subsequent) request to the SA members (e.g., a spatial localization service, a spatial anchor service, and/or the like). The SA members may (e.g., then) verify that they operate on coherent copies of the spatial map (e.g., based on a comparison of the version identifier from the AR and the version identifier from the subsequent SA members).

If a version mismatch exists between the version provided by the service consumer and the (e.g., current) version in the SA member service, the SA member may retrieve the requested resource version (e.g., directly) from the resource database using previously obtained information (e.g., resource URI, access credentials, and/or the like), or the SA member may send a request to the ASMF to obtain the (e.g., necessary) information to retrieve the (e.g., required) resource version (e.g., from the ASMF-S).

Although features and elements described herein are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit/receive unit (WTRU), the WTRU comprising:
a processor configured to:
detect a request to create a service association (SA), wherein the request indicates a coherent resource and indicates policy information associated with creating a coherent resource policy;
generate the coherent resource policy based on the coherent resource and the policy information;
generate an SA create message, wherein the SA create message comprises an indication of the coherent resource and the coherent resource policy;
send the SA create message to a network node, wherein the SA create message indicates a request to create the SA based on the coherent resource and the coherent resource policy; and
receive an SA create response message from the network node, wherein the SA create response indicates that the SA has been created and an SA identifier (SAID) based on the coherent resource policy.

2. The WTRU of claim 1, wherein the processor is further configured to:
detect a request to update the coherent resource, wherein the request to update the coherent resource indicates the coherent resource and the SAID;
send a coherent resource update request to the network node, wherein the coherent resource update request indicates a request to update the coherent resource, a coherent resource version identifier, and the SAID; and
receive a coherent resource update response, wherein the coherent resource update response indicates that the coherent resource has been updated, a version identifier for the coherent resource, and the SAID.

3. The WTRU of claim 1, wherein the SA create message further indicates at least one of requestor information, associated service information, or a version or a timestamp associated with the coherent resource.

4. The WTRU of claim 1, wherein the coherent resource is a spatial map, and wherein the SA create message further indicates at least one of a spatial mapping service, a spatial localization service, a spatial anchor service, or access information.

5. The WTRU of claim 1, wherein the SA create response message further indicates at least one of an authorized associated services management function (ASMF) operation for the WTRU or an SA identifier (SAID).

6. The WTRU of claim 1, wherein the information associated with creating the coherent resource policy comprises at least one of a resource type, a resource version, a resource information layer, a resource synchronization threshold, a resource consumer type, a resource consumer inter-dependency, a resource consumer state, an expected resource usage, a time, or a WTRU location.

7. The WTRU of claim 1, wherein the SA create message further indicates at least one of an associated services management function client component (ASMF-C) identifier, security credentials, a notification endpoint, or an external identifier to enable the network node to subscribe to event notifications.

8. The WTRU of claim 1, wherein the SA create message further indicates coherent resource information, wherein the coherent resource information comprises at least one of a resource identifier, a resource type, a resource location, a resource size, a resource version, resource access credentials, or a resource filter.

9. A wireless transmit/receive unit (WTRU), the WTRU comprising:
a processor, wherein the processor is configured to:
detect a request to join a service association (SA), wherein the request to join the SA indicates an SA identifier (SAID) associated with the SA, a coherent resource, and a coherent resource policy;
generate an SA join request message, wherein the SA join request message comprises an indication of the SAID associated with the SA, the coherent resource, and the coherent resource policy;
send the SA join request message to a network node; and
receive an SA join response message, wherein the SA join response message indicates that the WTRU has joined the SA, an SA member identifier (SAMID), and information associated with the coherent resource.

10. The WTRU of claim 9, wherein the processor is further configured to receive a coherent resource update message from the network node, wherein the coherent resource update message indicates that the coherent resource has been updated, a version identifier for the coherent resource, and the SAMID.

11. The WTRU of claim 10, wherein the processor is further configured to retrieve an updated coherent resource based on the version identifier for the coherent resource and the SAMID.

12. The WTRU of claim 9, wherein the SA join request message further comprises an indication of at least one of security credentials, a notification endpoint, or a WTRU identifier.

13. The WTRU of claim 9, wherein the SA join response message further indicates a coherent resource update configuration for the WTRU based on the coherent resource policy, and wherein the coherent resource update configuration identifies a synchronization threshold associated with updating the coherent resource.

14. The WTRU of claim 9, wherein the coherent resource policy comprises at least one of a resource type, a resource version, a resource information layer, a resource synchronization threshold, a resource consumer type, a resource consumer inter-dependency, a resource consumer state, an expected resource usage, a time, or a WTRU location.

15. The WTRU of claim 9, wherein the SA join request message further indicates coherent resource information, wherein the coherent resource information comprises at least one of a resource identifier, a resource type, a resource location, a resource size, a resource version, resource access credentials, or a resource filter.

16. A first network node comprising:
a processor configured to:
receive a service association (SA) create request message from a wireless transmit/receive unit (WTRU), wherein the SA create request message indicates a coherent resource, a coherent resource policy, and a request to create an SA based on the coherent resource and the coherent resource policy;
create the SA, wherein the SA comprises an SA identifier (SAID) based on the coherent resource and the coherent resource policy;
send an SA create response message to the WTRU, wherein the SA create response message indicates that the first network node created the SA and the SAID;
receive an SA join request message from the WTRU, wherein the SA join request message indicates a request to join the SA, the SAID, the coherent resource, and the coherent resource policy;
based on the SA join request message, generate an SA member identifier (SAMID), wherein the SAMID is generated based on a determination to add the WTRU to the SA; and
send an SA join response message to the WTRU, wherein the SA join response message indicates that the WTRU has joined the SA and the SAMID.

17. The first network node of claim 16, wherein the processor is further configured to:
receive a coherent resource update request from the WTRU, wherein the coherent resource update request indicates a request to update the coherent resource, a coherent resource version identifier, and the SAID; and
send a coherent resource update response to the WTRU, wherein the coherent resource update response indicates that the coherent resource has been updated, and a version identifier for the coherent resource.

18. The first network node of claim 17, wherein the processor is further configured to:
based on the received coherent resource update request, determine an SA member associated with the coherent resource; and
send the coherent resource update notification to the SA member, wherein the coherent resource update notification indicates that the coherent resource has been updated, a version identifier for the coherent resource, and the SAMID.

19. The first network node of claim 16, wherein the SA create request message further indicates a resource filter that identifies the coherent resource, and wherein the processor is further configured to create the SA based on the resource filter.

20. The first network node of claim 16, wherein the SA create request message further indicates at least one of an associated services management function client component (ASMF-C) identifier, security credentials, a notification endpoint, or an external identifier to enable the network node to subscribe to event notifications.
